(19) United States
(12) Patent Application Publication
(10) Pub. No.: US 2022/0253588 A1
(43) Pub. Date: Aug. 11, 2022

(54) PAGE PROCESSING METHOD AND RELATED APPARATUS

(71) Applicant: TENCENT TECHNOLOGY (SHENZHEN) COMPANY LIMITED, Shenzhen (CN)

(72) Inventors: Guangdong SUN, Shenzhen (CN); Canhui HUANG, Shenzhen (CN); Yuan HAI, Shenzhen (CN); Jiasheng HUANG, Shenzhen (CN); Chao LIN, Shenzhen (CN); Zhiwei GUO, Shenzhen (CN); Sicheng HUANG, Shenzhen (CN); Yuansheng XUE, Shenzhen (CN)

(21) Appl. No.: 17/730,009

(22) Filed: Apr. 26, 2022

Related U.S. Application Data
(63) Continuation of application No. PCT/CN2021/078000, filed on Feb. 26, 2021.

(30) Foreign Application Priority Data
Apr. 27, 2020 (CN) 202010343611.1

(51) Int. Cl. G06F 40/106; G06F 40/14; G06F 40/154; G06F 40/166; G06F 40/197

(52) U.S. Cl. CPC G06F 40/106; G06F 40/14; G06F 40/197; G06F 40/166; G06F 40/154

(57) ABSTRACT

Embodiments of this application provide a page processing method and related apparatus. The method includes previewing a target page in an application program; obtaining a page structure of the previewed target page, the page structure of the target page identifying a layout of page elements of the target page in the target page; obtaining a page structure of a skeleton screen corresponding to the target page based on the page structure of the target page, the page structure of the skeleton screen identifying a layout of placeholder elements of the skeleton screen on the skeleton screen, the placeholder elements being obtained by processing the page elements; and generating a view file of the skeleton screen according to the page structure of the skeleton screen, the skeleton screen being displayed before the target page is loaded.

### RELATED APPLICATIONS

This application is a continuation application of PCT Application No. PCT/CN2021/078000, filed on Feb. 26, 2021, which claims priority to Chinese Patent Application No. 202010343611.1, entitled “METHOD AND APPARATUS FOR PROCESSING APPLICATION PROGRAM, AND DEVICE” filed with the China National Intellectual Property Administration on Apr. 27, 2020. The two applications are both incorporated herein by reference in their entirety.

### FIELD OF THE TECHNOLOGY

This application relates to the field of computer technologies, and specifically, to application program processing.

### BACKGROUND OF THE DISCLOSURE

In a process of loading and displaying a page (such as a web page or a service page in an application program), the user needs to wait for a certain time. A loading page is usually displayed during the loading process of the page. As shown in FIG. 1, the loading page may be a blank page (for example, on the left of FIG. 1), or may be a rotating chrysanthemum (for example, on the right side of FIG. 1) displayed on the loading page, prompting the user that the page is being loaded.

### SUMMARY

Embodiments of this application provide a page processing method and related apparatus, which can quickly generate a view file of a skeleton screen corresponding to a target page based on a page structure of the target page, so that the implementation process of the skeleton screen is not only efficient but also flexible.

One aspect of this application provides a page processing method. The method includes previewing a target page in an application program; obtaining a page structure of the previewed target page, the page structure of the target page identifying a layout of page elements of the target page in the target page; obtaining a page structure of a skeleton screen corresponding to the target page based on the page structure of the target page, the page structure of the skeleton screen identifying a layout of placeholder elements of the skeleton screen on the skeleton screen, the placeholder elements being obtained by processing the page elements; and generating a view file of the skeleton screen according to the page structure of the skeleton screen, the skeleton screen being displayed before the target page is loaded.

Another aspect of this application provides a page processing method. The method includes displaying a preview interface, the preview interface comprising a target page previewed in an application program, and the preview interface further comprising a trigger control; when the trigger control is selected, generating a view file of a skeleton screen corresponding to the target page according to the following method. The method includes previewing a target page in an application program; obtaining a page structure of the previewed target page, the page structure of the target page identifying a layout of page elements of the target page in the target page; obtaining a page structure of a skeleton screen corresponding to the target page based on the page structure of the target page, the page structure of the skeleton screen identifying a layout of placeholder elements of the skeleton screen on the skeleton screen, the placeholder elements being obtained by processing the page elements; and generating a view file of the skeleton screen according to the page structure of the skeleton screen, the skeleton screen being displayed before the target page is loaded. The page processing method further includes obtaining a view file of the target page, and establishing a mapping relationship between the view file of the target page and the view file of the skeleton screen; and packaging the view file of the target page and the view file of the skeleton screen that have the mapping relationship into a program package of the application program.

According to another aspect, an embodiment of this application provides a page processing method, including: reading a view file of a target page and a view file of a skeleton screen from a program package of an application program, the view file of the target page and the view file of the skeleton screen having a mapping relationship, and the view file of the skeleton screen being generated according to the method for processing an application program; when it is determined to load the target page, rendering and displaying the skeleton screen according to the view file of the skeleton screen before the target page is loaded; loading dynamic resource data in the target page; and rendering and displaying the target page according to the view file of the target page and the loaded dynamic resource data in the target page, to replace the skeleton screen with the target page.

According to another aspect, an embodiment of this application provides a page processing device, including: a memory and a processor coupled to the memory. The processor is configured to perform: previewing a target page in an application program; obtaining a page structure of the previewed target page, the page structure of the target page identifying a layout of page elements of the target page in the target page; obtaining a page structure of a skeleton screen corresponding to the target page based on the page structure of the target page, the page structure of the skeleton screen identifying a layout of placeholder elements of the skeleton screen on the skeleton screen, the placeholder elements being obtained by processing the page elements; and generating a view file of the skeleton screen according to the page structure of the skeleton screen, the skeleton screen being displayed before the target page is loaded.

According to another aspect, an embodiment of this application provides a non-transitory computer-readable storage medium, storing one or more instructions, the one or more instructions being adapted to be loaded by a processor to perform the page processing method.

In embodiments of this application, in a process of previewing a target page of an application program, a page structure of the previewed target page is obtained, page elements are directly processed based on the page structure of the target page, to obtain a page structure of a skeleton screen corresponding to the target page, and a view file of the skeleton screen is then generated according to the page structure of the skeleton screen, the skeleton screen being used for being displayed before the target page is loaded. In this process, a view file of a corresponding skeleton screen is automatically generated by directly obtaining the page structure of the target page. There is no need to separately write code for the skeleton screen, avoiding code invasion, and regardless of how the target page changes, the view file of the corresponding skeleton screen can be quickly generated by previewing. As such, the implementation process of the skeleton screen is not only efficient but also flexible.

### BRIEF DESCRIPTION OF THE DRAWINGS

To describe the technical solutions in the embodiments of this application more clearly, the following briefly introduces the accompanying drawings required for describing the embodiments. Apparently, the accompanying drawings in the following description show only some embodiments of this application, and a person of ordinary skill in the art may still derive other drawings from these accompanying drawings without creative efforts.

FIG. 1 is a schematic diagram of a loading page in the related art.

FIG. 2 is a schematic diagram of a starting process of an application program according to an exemplary embodiment of this application.

FIG. 3 is a schematic diagram of a skeleton screen according to an exemplary embodiment of this application.

FIG. 4 is a schematic structural diagram of a page processing system according to an exemplary embodiment of this application.

FIG. 5 is a schematic flowchart of a page processing method according to an exemplary embodiment of this application.

FIG. 6 is a schematic diagram of a document object model tree according to an exemplary embodiment of this application.

FIG. 7 is a schematic diagram of replacing a key element with a placeholder element according to an exemplary embodiment of this application.

FIG. 8 is a schematic flowchart of processing different types of page elements according to an exemplary embodiment of this application.

FIG. 9a is a schematic diagram of replacing a text element with a placeholder element according to an exemplary embodiment of this application.

FIG. 9b is a schematic diagram of replacing an image element with a placeholder element according to an exemplary embodiment of this application.

FIG. 9c is a schematic diagram of replacing a button element with a placeholder element according to an exemplary embodiment of this application.

FIG. 9d is a schematic diagram of replacing a form element with a placeholder element according to an exemplary embodiment of this application.

FIG. 9e is a schematic diagram of replacing a pseudo-class element with a placeholder element according to an exemplary embodiment of this application.

FIG. 9f is a schematic diagram of replacing a native component with a placeholder element according to an exemplary embodiment of this application.

FIG. 10 is a flowchart of another page processing method according to an exemplary embodiment of this application.

FIG. 11 is a schematic diagram of a preview interface according to an exemplary embodiment of this application.

FIG. 12 is a flowchart of another page processing method according to an exemplary embodiment of this application.

FIG. 13 is a schematic structural diagram of a page processing apparatus according to an exemplary embodiment of this application.

FIG. 14 is a schematic structural diagram of another page processing apparatus according to an exemplary embodiment of this application.

FIG. 15 is a schematic structural diagram of still another page processing apparatus according to an exemplary embodiment of this application.

FIG. 16 is a schematic structural diagram of a page processing device according to an exemplary embodiment of this application.

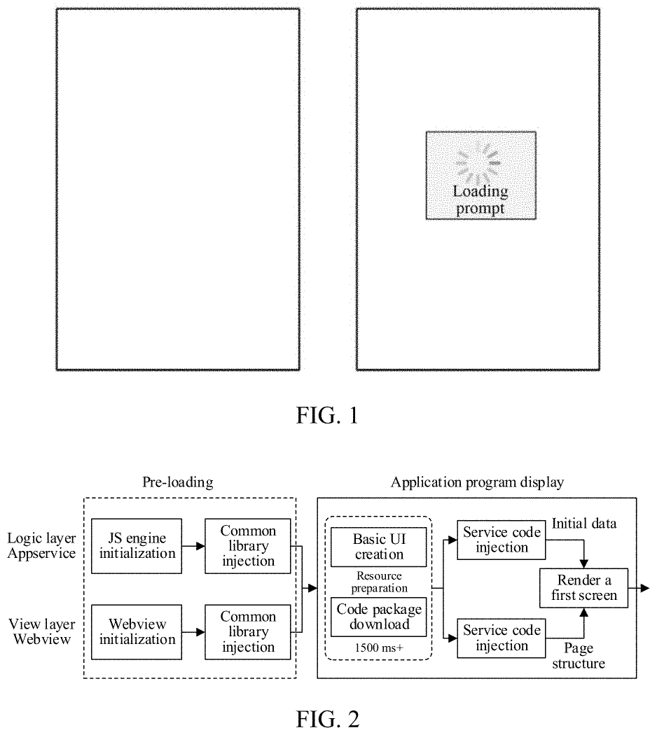

### DESCRIPTION OF EMBODIMENTS

The technical solutions in the embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

Application programs involved in the embodiments of this application may include various types of programs running on a terminal, such as an application (APP) and an instant app program (an applet).

For ease of description, an example in which the application program is the instant app program, that is, an application program that can be used without downloading and installing is used for description in the following embodiments. Such an application program is referred to as an applet, which usually runs on a client as a child program. In this case, the client and the application program have a parent-child relationship, the client is used as a parent program of the application program, and the application program is used as a child program of the client. The client (also referred to as an application client or an APP client) is a program that is downloaded and installed in a terminal and runs on the terminal. The terminal may include various clients, including but not limited to an instant messaging (IM) client (such as a WeChat client and a QQ client), a social networking service (SNS) client (such as a Weibo client and a map client with social functions), a content service client (such as a news client), an image processing client, a search client, and the like. Unless otherwise specified, the application programs mentioned in the subsequent embodiments of this application are all described by using an example in which application programs (that is, applets) run on the various clients of the terminal.

The application program (applet) is an underlying architecture of a dual-thread mode. A logic layer and a view layer are divided in a running environment. The logic layer includes a logic file, and the logic file may be a JS file. The JS file is run on the logic layer by using a JsCore thread, that is, tasks of the logic layer are all executed in the logic thread (that is, the JsCore thread). The view layer includes a view file. The view file includes a view code file (for example, a wxml file) and a view style file (for example, a wxss file). The logic layer renders a page according to a view file of the page by using a Webview thread. An application program includes a plurality of pages, so that the view layer includes a plurality of Webview threads, that is, tasks of the view layer are all executed in rendering threads (that is, the Webview threads).

FIG. 2 is a schematic diagram of a starting process of an application program according to an exemplary embodiment of this application. As shown in FIG. 2, the starting process of the application program includes a pre-load process and a display process. The pre-load process may be divided into pre-loading of a view layer and pre-loading of a logic layer. A pre-load process of the view layer may include Webview initialization and common library injection, and a pre-load process of the logic layer may include JS engine (that is, JsCore) initialization and common library injection. The display process includes a resource preparation stage (such as basic user interface (UI) creation and code package download), a service code injection stage, and a first screen rendering stage. A certain time is required for each necessary step in the starting process of the application program, so that a user needs to wait during this time. First meaningful paint (FMP) may be adopted to measure the length of time the user waits. FMP refers to a duration between a time point when the application program is triggered to be started and a time point when a first screen page of the application program is displayed. That is, FMP is used for reflecting a time required for loading and rendering the first screen page of the application program. A greater FMP value indicates that a time required for the user from triggering the application program to viewing complete content of the first screen page of the application program is longer, and starting performance of the application program is worse. On the contrary, a smaller FMP value indicates that a time required for the user from triggering the application program to viewing complete content of the first screen page of the application program is shorter, and the starting performance of the application program is better.

For an application program (applet) with an underlying architecture in a dual-thread mode, this embodiment of this application provides a skeleton screen solution. The solution is: displaying a skeleton screen corresponding to a target page in a process of loading and rendering content of a first screen of the target page. The skeleton screen can display, before data of the target page is loaded, a skeleton page that depicts a general structure of page elements in the target page. In a process of waiting for the target page to be loaded, the user may sense a page structure of the target page from the skeleton screen, what type of page elements the target page includes, and a position of each page element in the target page, thereby shifting the focus of attention of the user to the page structure, reducing the anxiety of the user while waiting, and improving the competitiveness of the application program and the user experience. The so-called skeleton screen is a page used for describing a general structure of the page elements in the target page before the data in the target page of the application program is loaded. A basic principle of the skeleton screen is a process of following the page structure of the target page in the application program, and performing style coverage on the page elements in the target page by using placeholder elements, so that the page elements are displayed as gray blocks. The target page herein may be any page in the application program. In one embodiment, the target page may be a first service page to be displayed in the application program. The page elements in the target page may refer to a text, an image, a button, and the like in the target page. The placeholder elements may be color blocks including various colors and stripes, such as gray blocks. A position and a style of the placeholder element in the skeleton screen correspond to a position and a style of the page element in the target page, and a placeholder element corresponding to the page element in the target page may be found in the skeleton screen. In this embodiment of this application, the skeleton screen is first rendered and displayed before the target page of the application program is loaded, and after the data of the target page is loaded, the placeholder element in the skeleton screen is replaced with the data of the page element of the target page. Accordingly, compared with a solution of displaying a blank loading page or displaying a rotating chrysanthemum in the loading page, the skeleton screen may display the position and the style of each page element in the target page, which can optimize the loading experience.

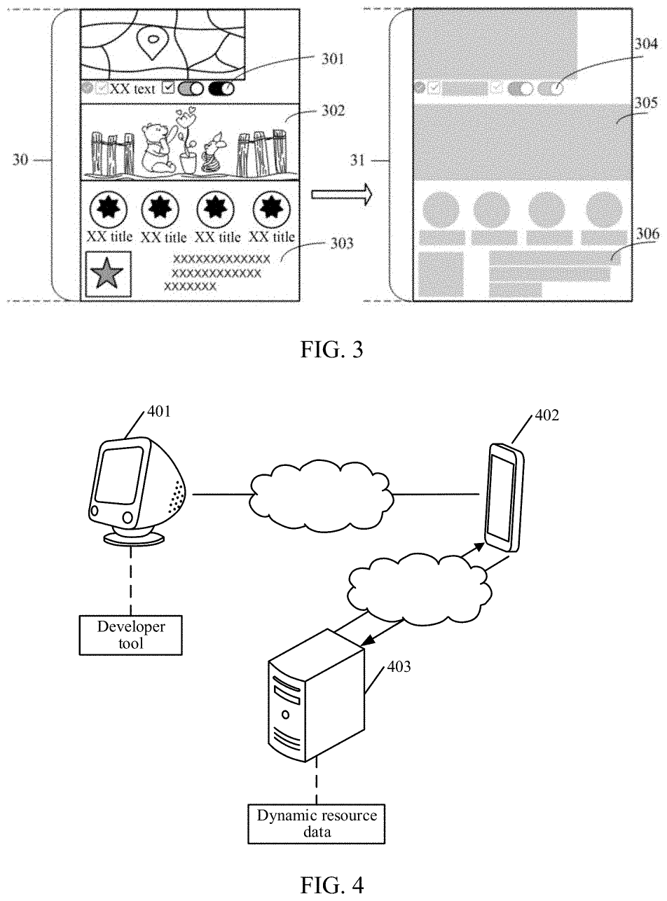

FIG. 3 is a schematic diagram of a skeleton screen according to an exemplary embodiment of this application. Structures of a target page 30 and a skeleton screen 31 corresponding to the target page 30 are shown in FIG. 3. The target page 30 is any page in any application program, for example, may be a main service page in an application program (that is, a first page that needs to be rendered and displayed after the application program is started). The target page 30 includes a plurality of page elements, such as a button element 301, an image element 302, and a text element 303. The skeleton screen 31 includes a plurality of placeholder elements, such as placeholder elements 304 to 306, and the placeholder elements are generally represented as gray blocks. It may be seen from FIG. 3 that page structures of the target page 30 and the skeleton screen 31 are roughly the same. The page elements in the target page 30 are replaced with gray placeholder elements in the skeleton screen 31. For example, the button element 301 is replaced with the placeholder element 304, the image element 302 is replaced with the placeholder element 305, and the text element 303 is replaced with the placeholder element 306. In addition, a position of the page element in the target page 30 is consistent with a position of the corresponding placeholder element in the skeleton screen 31. Further, as shown in FIG. 3, display effects of the placeholder elements corresponding to the page elements of different types are also different, for example, the placeholder element corresponding to the file element 303 is in a gray stripe shape, while the placeholder element 305 corresponding to the image element 302 is in a gray rectangular block shape, and the placeholder element 304 corresponding to the button element 301 presents a gray block with the same shape as the button element.

As described above, the application program includes a logic layer and a view layer, the display of the skeleton screen corresponding to the target page is performed by establishing a rendering task in the view layer and executing the rendering task in a Webview thread. Therefore, a view file of the skeleton screen corresponding to the target page needs to be generated first, and the skeleton screen is then rendered and displayed by the view layer according to the view file of the skeleton screen. There are mainly the following several methods to implement a conventional web page. One method is to write code, that is, a developer specially writes a code file of the skeleton screen according to a page structure of the target page, so as to implement the skeleton screen. This method is inefficient and has severe service coupling problems, that is, once the page structure of the target page changes, the code needs to be rewritten. Therefore, this method is not suitable for the implementation of a skeleton screen for an applet page. Another method is to customize the skeleton screen by using a plug-in on a web side. This method is only applicable to an architecture of a single-threaded mode such as the web side. However, in this embodiment of this application, although the skeleton screen corresponding to the target page of the application program is a page, the skeleton screen is a page realized based on an architecture of the applet. The applet is an application program that is free of installation and runs on the client, and has an underlying architecture of a dual-thread mode, which is completely different from an underlying architecture of the web side. Therefore, this method is also not suitable for the implementation of the skeleton screen for the applet page. Based on this, the embodiments of this application provide a page processing solution. In this solution, the skeleton screen for the target page in the application program (that is, the applet) that is free of installation and has a dual-thread mode architecture can be realized, and a view file of the skeleton screen for the target page in the applet can be generated more conveniently, thereby optimizing a starting process of the application program and optimizing loading experience of the target page. The solution for realizing the skeleton screen of this application has the advantages of no code intrusion, low use costs, and flexible configuration.

The following describes a page processing method provided in the embodiments of this application in detail with reference to the accompanying drawings.

FIG. 4 is a schematic structural diagram of a page processing system according to an exemplary embodiment of this application. As shown in FIG. 4, the page processing system may include a terminal 401, a terminal 402, and a server 403. It may be understood that the quantity of terminals and the quantity of servers included in the system are merely for illustration, and the quantity of terminals and the quantity of servers are not limited in this application. The terminal 401 or the terminal 402 may be a personal computer (PC), a PDA, a mobile phone, a wearable intelligent device, or the like. The server 403 may be of various types, such as an independent server, cluster server, or a cloud server.

The terminal 401 may be a terminal used by a developer of an application program. The terminal 402 may be a terminal corresponding to a user of an application program. At least one client may be installed and run on the terminal 402. The client supports the running of an application program, and the application program may be an instant app program (that is, an applet) that runs on the client. For example, a WeChat client is installed on the terminal 402, and a news applet, a shopping applet, a game applet, and the like may be run on the WeChat client.

In one embodiment, a developer of an application program may use the terminal 401 to develop and debug the application program, for example, the development and debugging of the application program may be implemented with the help of development and debugging functions provided by a developer tool in the terminal 401. In a process of developing and debugging the application program, the terminal 401 may provide a preview function, and the developer can preview each page in the application program by using the preview function, and the terminal 401 may generate a view file of a skeleton screen corresponding to a target page based on a page structure of the previewed target page. Accordingly, an original style layout of the target page is multiplexed to automatically generate the view file of the skeleton screen, and the skeleton screen is realized conveniently without code invasion.

In one embodiment, after the file of the skeleton screen corresponding to the target page is generated, the terminal 401 further needs to establish a mapping relationship between the target page and the skeleton screen, and injects the mapping relationship into a program package developed by the developer for the application program. Accordingly, after the developer releases the program package of the application program, a skeleton screen implementation solution is introduced into the starting process of the application program.

In one embodiment, the user may use the released application program by using the terminal 402. In a process of starting the application program, when the target page in the application program is loaded, the skeleton screen of the target page can be first rendered and displayed based on the view file of the skeleton screen that has a mapping relationship with the target page in the program package of the application program, and after content of the target page is loaded, the target page is then used to replace the skeleton screen. In this process, the anxiety of the user while waiting can be effectively reduced, and the competitiveness of the application program and the user experience can be improved. In this implementation, resource data of the application program is stored in the server 403. Page elements in a page of the application program include static resource data and dynamic resource data. The static resource data is data such as some fixed text and images obtained without request during a page loading process. The static resource data forms view files of the page in application program and is encapsulated into the program package of the application program and stored in the terminal 402. The dynamic resource data is data such as user interaction data and changed text and images that needs to be obtained from the server 403 in real time. In the process of loading the page, the terminal needs to request and pull the dynamic resource data of the page element from the server 403, integrate the static resource data in the terminal 402, and then perform rendering to display the page.

It may be understood that the foregoing terminal 401 and terminal 402 may be the same terminal or may be different terminals, which is not limited in this embodiment of this application.

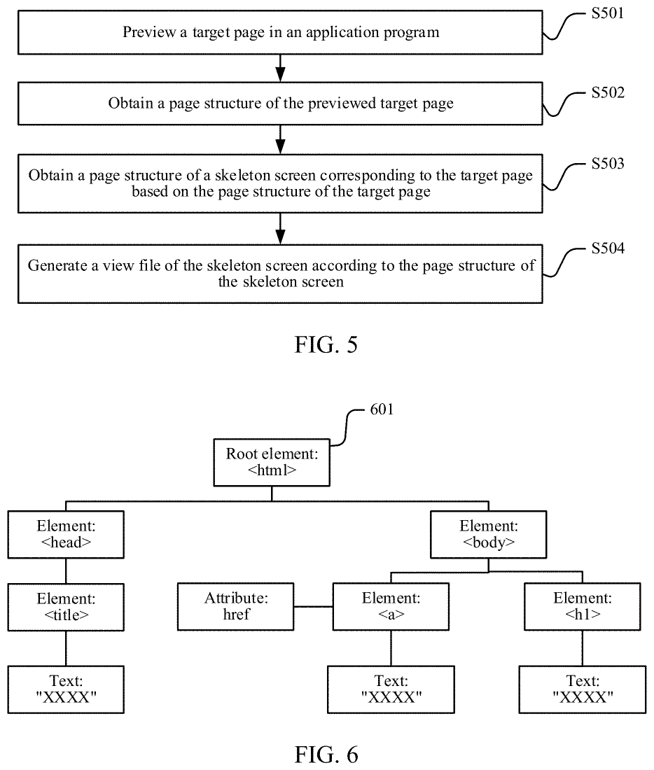

FIG. 5 is a schematic flowchart of a page processing method according to an exemplary embodiment of this application. The page processing method may be performed by the terminal 401 shown in FIG. 4. The method includes but is not limited to steps S501 to S504.

S501. Preview a target page in an application program.

According to an underlying architecture of the application program, implementation of a page of the application program needs to include a logic file and a view file. The logic file is a file running in a logic layer of the application program, and may be a JS file. The view file is a file running in a view layer of the application program, including a view code file and a view style factor file. In this embodiment, the view code file may be a wxml file, and the view style file may be a wxss file. In one embodiment, the terminal 401 may provide a developer tool, the developer tool has functions such as development, compilation, preview, and debugging of the application program, and a developer can develop and debug the application program by using the developer tool. After a logic file and a view file of a target page are formed by compiling the target page of the application program, the target page of the application program may be previewed based on the logic file of the target page and by invoking a preview function of the developer tool. When the target page needs to be displayed in the application program, rendering and display may be performed according to the view file of the target page.

S502. Obtain a page structure of the previewed target page, the page structure of the target page being used for identifying a layout of page elements of the target page in the target page.

The target page further includes configuration information, and the configuration information is used for describing a configuration item of a display effect of each page element in the target page. The configuration information of the target page includes display configuration fields of the page elements, and the display configuration fields of the page elements are used for indicating that the page elements are displayed or hidden in the target page. For example, the display configuration field may be a hidden configuration field, if the hidden configuration field is configured as a css selector that needs to be hidden, it indicates that the page element is hidden; and otherwise, it indicates that the page element is displayed. In one embodiment, the page structure of the target page is determined by the logic file and the configuration information of the target page. In other words, the page structure of the target page may be obtained according to the logic file and the configuration information of the target page, and the page structure of the target page identifies the layout of the page elements of the target page in the target page. For example, a position and a style of a specific page element are defined in the logic file of the target page, and the configuration information of the target page indicates that the page element is hidden, then a corresponding position of the page element in the target page is blank when the target page is displayed, that is, the page element is hidden and is not displayed in the target page.

S503. Obtain a page structure of a skeleton screen corresponding to the target page based on the page structure of the target page.

The page structure of the skeleton screen is used for identifying a layout of placeholder elements of the skeleton screen in the skeleton screen, the placeholder elements being obtained by processing the page elements.

The page elements of the target page include key elements and non-key elements. The key elements include the page elements that are in the target page and in which the display configuration fields are used for indicating that the target page is displayed, that is, the key elements are those that are visible on a first screen. The non-key elements include other page elements other than the key elements in the target page, that is, the non-key elements include first screen hidden elements and non-first screen elements. Types of the key elements include at least one of the following: a text element, an image element, a button element, a form element, a pseudo-class element, or a native component. In this embodiment of this application, based on the page structure of the target page, the placeholder elements are determined by processing the key elements and the non-key elements differently, to obtain the page structure of the skeleton screen corresponding to the target page. Accordingly, the solution for obtaining the page structure of the skeleton screen is convenient, and may reduce the redundancy of code of the skeleton screen, so that a generation process of a skeleton screen file is more efficient.

S504. Generate a view file of the skeleton screen according to the page structure of the skeleton screen.

The view file of the skeleton screen includes a view code file of the skeleton screen and a view style file of the skeleton screen. In one embodiment, the view code file of the skeleton screen may be a wxml file used for describing a template of the skeleton screen, including a layout position of each placeholder element of the skeleton screen in the skeleton screen. The view style file of the skeleton screen may be a wxss file used for describing a style of each placeholder element in the skeleton screen.

The skeleton screen is used for being displayed before the target page is loaded, to reduce anxiety of the user during waiting.

In the embodiments of this application, in a process of previewing the target page of the application program, the page structure of the previewed target page is obtained, the page elements are directly processed based on the page structure of the target page, to obtain the page structure of the skeleton screen corresponding to the target page, and the view file of the skeleton screen is generated according to the page structure of the skeleton screen. In this process, the view file of the corresponding skeleton screen is automatically generated by directly obtaining the page structure of the target page. There is no need to separately write code for the skeleton screen, avoiding code invasion, and regardless of how the target page changes, the view file of the corresponding skeleton screen can be quickly generated by previewing, so that the implementation process of the skeleton screen is not only efficient but also flexible.

The following describes the processing process involved in step S503 in detail.

In one embodiment, the process of obtaining, based on the page structure of the target page, a page structure of a skeleton screen corresponding to the target page by processing the page elements includes: (1) Deleting the non-key elements in the page elements. This involves the processing on the non-key elements, and this processing process may be implemented by the following steps:

1. Parse the logic file of the target page, to convert the logic file of the target page into a document object model (DOM) tree, the DOM tree including a plurality of nodes, and one node being corresponding to one page element in the target page.

FIG. 6 is a schematic diagram of a DOM tree according to an exemplary embodiment of this application. The DOM tree is a tree structure that represents a logic file. The logic file is an html code file, and a DOM tree corresponding to the html code file is shown in FIG. 6. Each block 601 in FIG. 6 represents a node, the DOM tree includes a plurality of nodes, and each node corresponds to a page element described in the logic file. For example, a text element in the logic file corresponds to a text node in the DOM tree. In another example, an attribute element in the logic file corresponds to an attribute node in the DOM tree.

2. Crop the DOM tree according to the configuration information of the target page, to remove nodes in the DOM tree corresponding to the non-key elements in the target page.

Each node in the DOM tree carries attributes of respective corresponding page element, including a position attribute and a style attribute. The position attribute is used for describing a layout position (such as a width and a height of the page element, a distance from the page element to a top end of the page, and a distance from the page element to a left end of the page) of the page element in the target page, and the style attribute is used for describing a display effect (such as a font color, a background color, and a foreground color) of the page element in the target page. The DOM tree is cropped according to the attributes of each node, to remove the nodes corresponding to the non-key elements and only retain nodes corresponding to the elements that are visible on the first screen. This can reduce the redundancy of code of the skeleton screen, and a specific cropping method of the DOM tree may be carried out by the following programs:

```
//in first screen
export const inViewPort = {ele} =>{
  const rect = ele.getBoundingClientRect ( )
  return rect.top < window.innerHeight && rect.left <
  window.innerWidth
}
//whether to hide
const DISPLAY_NONE = /display:\s*none/
export const isDisplayNone = (ele) => {
  return DISPLAY_NONE.test(ele.getAttribute(″style″))
}
```

(2) Replacing the key elements with the placeholder elements to obtain the page structure of the skeleton screen. This involves the processing on the key elements.

The cropped DOM tree may only include nodes corresponding to the key elements in the target page. In one embodiment, a method for replacing the key elements in the target page with the placeholder elements to obtain the page structure of the skeleton screen may include the following steps:

1. Obtain the attributes of each node in the DOM tree, the attributes including the position attribute and the style attribute.

2. Perform attribute processing on the nodes in the cropped DOM tree, the attribute processing including determining the position attributes of the nodes as position attributes of the placeholder elements, and replacing the style attributes of the nodes with style attributes of the placeholder elements.

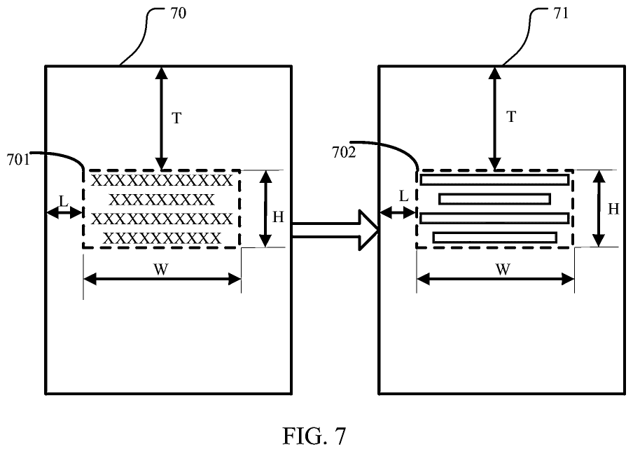

FIG. 7 is a schematic diagram of replacing a key element with a placeholder element according to an exemplary embodiment of this application. A specific key element in a target page 70 is a text element 701, which corresponds to a corresponding node in the DOM tree, and a position attribute of the node may include: a distance T from the text element 701 to a top end of the target page, a distance L from the text element 701 to a left side of the target page, and a width W and a height H of the text element 701. In the processing process, the position attribute of the text element 701 is directly assigned to a corresponding placeholder element 702, that is, a position attribute of the placeholder element 702 in a skeleton screen 71 includes: a distance T from the placeholder element 702 to a top end of the skeleton screen, a distance L from the placeholder element 702 to a left side of the target page, and a width W and a height H of the placeholder element 702. It may be seen from the figure that the text element 701 and the corresponding placeholder element 702 have the same layout position. In addition, a style attribute of the placeholder element 702 corresponding to the text element 701 is gray stripes, so that a style attribute of the text element 701 may be simultaneously modified to the style attribute corresponding to the gray stripes.

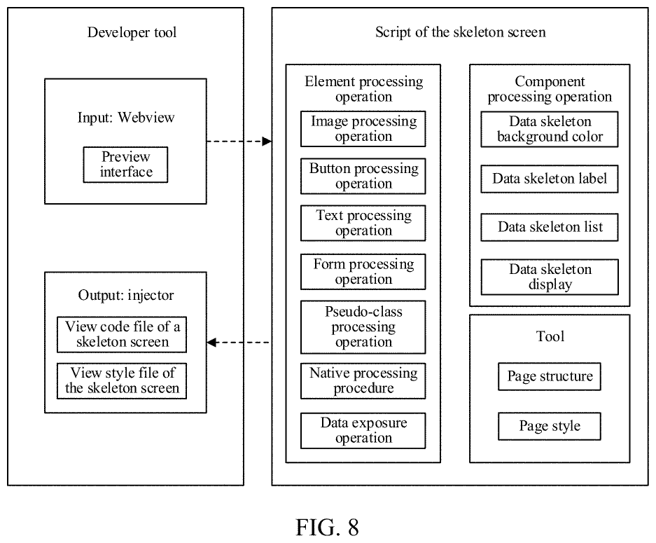

Display effects of the placeholder elements corresponding to the page elements of different types are also different. A page of an applet may be understood, at a view layer, as being formed by a component tree. Components in the component tree may be official built-in components of a client at which the applet is located, or may be components customized by the developer. When the compiled target page is previewed by using the developer tool, the logic file of the target page is used, and the logic file is an html code file corresponding to the DOM tree. Content of the page elements is stored in a form of html tags. However, the view file of the target page is used when the target page is displayed in the application program. The content of each page element is stored in a form of a component tag and corresponds to the component tree. When the target page is displayed in the application program, an internal structure of the component is unfolded, and each component is a node on the component tree. Therefore, analysis needs to be performed on the page elements of different types in a targeted method. FIG. 8 is a schematic flowchart of processing different types of page elements according to an exemplary embodiment of this application. As shown in FIG. 8, a process of analysis includes but is not limited to:

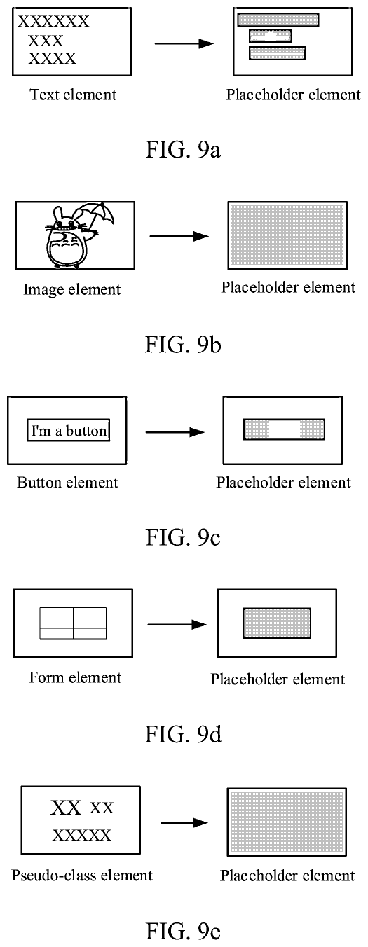

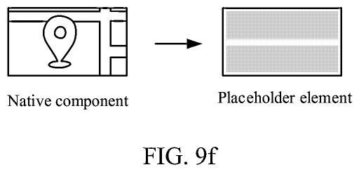

(1) Text element processing. The text element includes a text component, a view component, a cover-view component, and the like, and the text element is replaced with a corresponding placeholder element having gray stripes (as shown in FIG. 9a). The following analyzes the specific replacement process by using a text component as an example.

An internal structure of the text component is as follows:

<!-- original text node -->
<text>text content</text>
<!-- unfolded text node -->
<wx-text>
<span id=″raw″ style=″display:none;″>text content</span>
<span id=″main″>text content</span>
</wx-text>

The original text node is the node on the DOM tree. Text content of the text element in the previewed target page is stored by two <text> tags. The text content of the text element is eventually written into a component tag in the view file of the target page, and specifically, into the span node whose id is raw and main in the component tree. Therefore, when the text element is replaced, the text element needs to be parsed. One method is to record each text node in the DOM tree, obtain the text content of the text node, perform mapping between the DOM tree and the component tree, and perform backfill on the text content when wxml code is generated. However, in this method, it is necessary to learn the implementation details of each component, which is time-consuming and laborious, and is inefficient. Another method is to delete, in the wx-text nodes in the unfolded component tree, internal nodes and only retain the text content without considering the internal structure of the component. A style of the text element is set on the wx-text node, which does not affect the layout and has high processing efficiency. Details are as follows:

<!-- text node obtained after removing internal structure->
<wx-text>text content</wx-text>

Subsequently, a style attribute of the processed text node is replaced with a style attribute of a placeholder element, to obtain the text node in the skeleton screen as follows:

```
  <!-- text node in skeleton screen-->
  <text class=″sk-transparent sk-text-14-2857-62
  sk-text″ style=″background-size:
100% 1.4rem;″>text content</text>
```

(2) Image element processing. Avatars of the image elements such as an image component, an icon component, a cover-image component, and an open-data component are replaced with corresponding placeholder elements in a shape of a gray rectangle or circle (as shown in FIG. 9b).

The image component in a view file of the applet page is not constructed by an img tag in the logic file, but is realized by a background image. Therefore, when the image element is processed, an src attribute of the image element needs to be removed, and a background color (gray) of the placeholder element is added for the image component to implement replacement. In addition, for the icon component, a color attribute of the icon component may be set as the color (gray) of the placeholder element to implement replacement.

(3) Button element processing. The button element such as a button component or an element with an attribute of role=button is replaced with a corresponding placeholder element having the same shape as that of a button (as shown in FIG. 9c).

(4) Form element processing. The form element such as a radio selector component, a switch selector component, or a checkbox selector component is replaced with a corresponding placeholder element in a shape of a gray rectangle (as shown in FIG. 9d). One method is to add a gray background color to the form element, but this style may conflict with an original style of the form element (such as the radio component). Another method is to set a color attribute of the form element to a color attribute configured for the button element, and remove a disabled attribute of the form element. The following analyzes the specific replacement process by using the radio selector component, the switch selector component, and the checkbox selector component as an example.

<!-- selector in original wxml -->
<radio checked color=′#eee′></radio>
<checkbox checked color=′#eee′ ><text>text content</text>
</checkbox>
<switch checked type=′checkbox′></switch>
<!-- selector in wxml in skeleton screen -->
<radio checked=″true″ color=″#EFEFEF″></radio>
<checkbox checked=″true″ color=″#EFEFEF″></checkbox>
<switch checked=″true″ type=″checkbox″ color=″#EFEFEF″>
</switch>

(5) Pseudo-class element processing. The pseudo-class element such as ::before or ::after is replaced with a corresponding placeholder element in a shape of a gray rectangle (as shown in FIG. 9e).

(6) Native component processing. The native component such as a camera, a live-player, a live-pusher, a video, a map, or a canvas is replaced with a corresponding placeholder element being a gray block (as shown in FIG. 9f). The native component is of a relatively high level, and the cover-view component is usually used to replace the native component to process the native component. For example, the cover-view component is used to replace the camera component. In another example, the cover-view component is used to replace the live-player.

3. Convert the DOM tree obtained after the attribute processing into a logic file of the skeleton screen.

4. Set configuration information for the skeleton screen, the configuration information of the skeleton screen being used for controlling a display effect of the skeleton screen; and determine the page structure of the skeleton screen according to the logic file of the skeleton screen and the configuration information of the skeleton screen.

The placeholder element corresponding to the image element, the placeholder element corresponding to the text element, and the placeholder element corresponding to the button element are important elements that need to be presented in the skeleton screen, while other parts are correspondingly unimportant, or internal details of other parts do not need to be considered. Therefore, the important elements and non-important elements may also be presented differently. The display effect of the skeleton screen may be optimized by using the configuration information of the skeleton screen. The configuration information of the skeleton screen may include a plurality of configuration items, as shown in Table 1 below:

TABLE 1
Configuration item list of the skeleton screen

| option | type | required | default | description |
|---|---|---|---|---|
| excludes | array | No | [ ] | If there is an element that does not |
| | | | | require skeleton processing, write |
| | | | | a CSS selector of the element into |
| | | | | this array |
| remove | array | No | [ ] | A configuration value of an |
| | | | | element that does not need to be |
| | | | | used to generate a page skeleton |
| | | | | and needs to be removed from a |
| | | | | DOM is a CSS selector of the |
| | | | | removed element |
| hide | array | No | [ ] | An element is hidden without |
| | | | | removing the element but with the |
| | | | | transparency of 0, and a |
| | | | | configuration value is a CSS |
| | | | | selector of the hidden element |
| empty | array | No | [ ] | An element in this array is a CSS |
| | | | | selector, and a sub-element of a |
| | | | | selected element is cleared |
| grayBlock | array | No | [ ] | An element in this array is a CSS |
| | | | | selector, and a selected element is |
| | | | | processed into a color block by a |
| | | | | plug-in. A color of the color block |
| | | | | is the same as that of a button |
| | | | | block. Internal elements are no |
| | | | | longer processed specially, and |
| | | | | text is hidden |

When the configuration item list is processed, to be as beautiful as possible, the configuration item list may be assimilated, and the following sub-items are clones of a first sub-item. For example, a configuration item list of an application program is not declared through ul/ol tags, so that data-* attributes are used for marking. Considering that other structures may be inserted into a configuration item list container, there are two declaration methods as follows: a direct child node of data-skeleton-list is processed as a clone of a first item; and elements with the same attribute as that of the data-skeleton-list are considered to be sub-items of the same list, and the two declaration methods may be performed using the following programs:

<!-- method I:contents of list container are all list items -->
<view wx:for=″{{array}}″ data-skeleton-list>
<view class=′list-item″>content of sub-item</view>
</view>
<!-- method II:other elements are inserted into list container -->
<view wx:for=″{{array}}″>
<view class=″other-block″>other</view>
<view class=″list-item″ data-skeleton-li=″goods″>content of
sub-item</view>
<view class=″list-item″ data-skeleton-li=″goods″
>content of sub-item</view>
<view class=″list-item″ data-skeleton-li=″goods″
>content of sub-item</view>
</view>

In one embodiment, in the embodiment shown in FIG. 4 to FIG. 9f, a script for generating the skeleton screen may be stored in the terminal 401, the script of the skeleton screen may be Skeleton.js, and the terminal 401 analyzes the page structure of the target page by running the script, to generate the view file of the skeleton screen.

In the embodiments of this application, in a process of previewing the target page of the application program, the page structure of the previewed target page is obtained, the page elements are directly processed based on the page structure of the target page, to obtain the page structure of the skeleton screen corresponding to the target page, and the view file of the skeleton screen is generated according to the page structure of the skeleton screen. In this process, the view file of the corresponding skeleton screen is automatically generated by directly obtaining the page structure of the target page. There is no need to separately write code for the skeleton screen, avoiding code invasion, and regardless of how the target page changes, the view file of the corresponding skeleton screen can be quickly generated by previewing, so that the implementation process of the skeleton screen is not only efficient but also flexible.

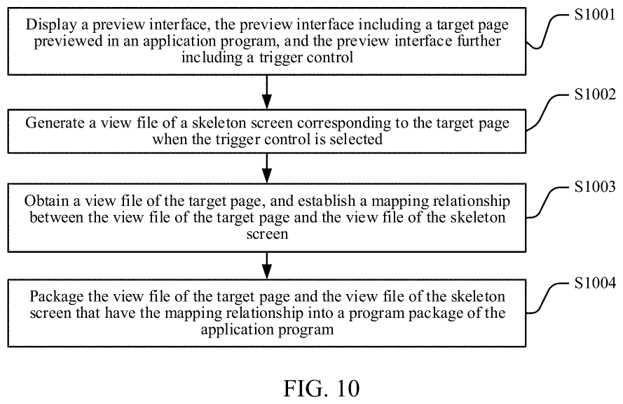

FIG. 10 is a flowchart of another page processing method according to an exemplary embodiment of this application. The page processing method may be performed by the terminal 401 shown in FIG. 4. The method includes but is not limited to steps S1001 to S1004.

S1001. Display a preview interface, the preview interface including a target page previewed in an application program, and the preview interface further including a trigger control.

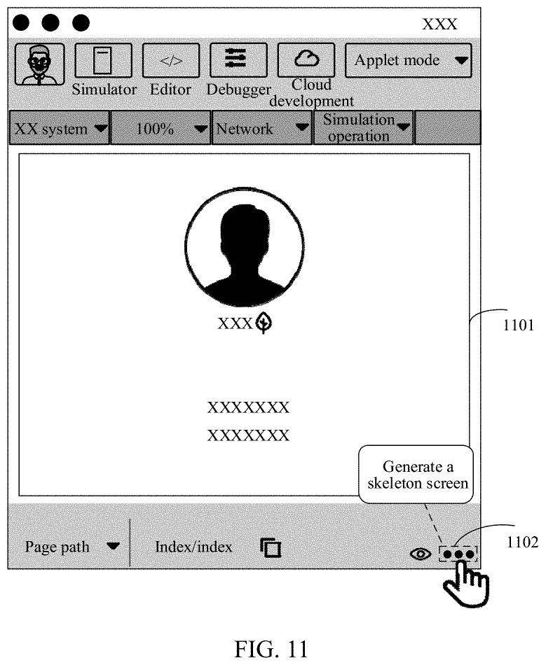

The terminal may provide a developer tool. The tool has a preview function and can provide a preview interface. The preview interface includes a trigger control, and the trigger control may be a button or an option entry. For example, FIG. 11 is a schematic diagram of a preview interface according to an exemplary embodiment of this application. A target page 1101 of a previewed application program and a trigger control 1102 are included in FIG. 11.

S1002. Generate a view file of a skeleton screen corresponding to the target page when the trigger control is selected.

For a specific process of generating the skeleton screen, reference may be made to the related descriptions of the embodiment shown in FIG. 4 to FIG. 9f, and details are not described herein again.

S1003. Obtain a view file of the target page, and establish a mapping relationship between the view file of the target page and the view file of the skeleton screen.

The view file of the target page includes a view code file and a view style file of the target page. Page elements include static resource data and dynamic resource data, and the view file of the target page is generated according to the static resource data of the page elements in the target page. In one embodiment, a method for establishing a mapping relationship between the view file of the target page and the view file of the skeleton screen may include: storing the view file of the target page and the view file of the skeleton screen in the same level path directory; and introducing a view code file of the skeleton screen into the view code file of the target page, and introducing a view style file of the skeleton screen into the view style file of the target page. For example, both the view file of the target page and the view file of the skeleton screen are located in a path directory of pages/index/index, and by using an example in which the view code file of the target page is pages/index/index.wxml, the view style file of the target page is pages/index/index.wxss, the view code file of the skeleton screen is index.skeleton.wxml, and the view style file of the skeleton screen is index.skeleton.wxss, the view code file (index.skeleton.wxml) of the skeleton screen is introduced into the view code file (pages/index/index.wxml) of the target page by using an import statement (such as include), and the view style file (index.skeleton.wxss) of the skeleton screen is introduced into the view style file (pages/index/index.wxss) of the target page by using an import statement (such as import). Accordingly, the mapping relationship between the view file of the target page and the view file of the skeleton screen is established.

S1004. Package the view file of the target page and the view file of the skeleton screen that have the mapping relationship into a program package of the application program.

The program package of the application program further includes a configuration file (for example, a configuration file: project.config.json) of the application program. The configuration file includes configuration information of the target page and configuration information of the skeleton screen. The configuration information (for example, configuration information: skeleton-config) of the skeleton screen is used for controlling a display effect of the skeleton screen.

In this embodiment of this application, by using the trigger control in the preview interface, the view file of the skeleton screen corresponding to the previewed target page may be triggered and generated, and the mapping relationship between the view file of the target page and the view file of the skeleton screen may be established; and the view file of the target page and the view file of the skeleton screen that have the mapping relationship are packaged into the program package of the application program. Accordingly, the program package of the application program including the view file of the target page and the view file of the skeleton screen is generated. After a developer releases the program package of the application program, a skeleton screen implementation solution is introduced into a starting process of the application program, which optimizes the starting process of the application program and a loading process of the target page, thereby helping improve user experience in using the application program.

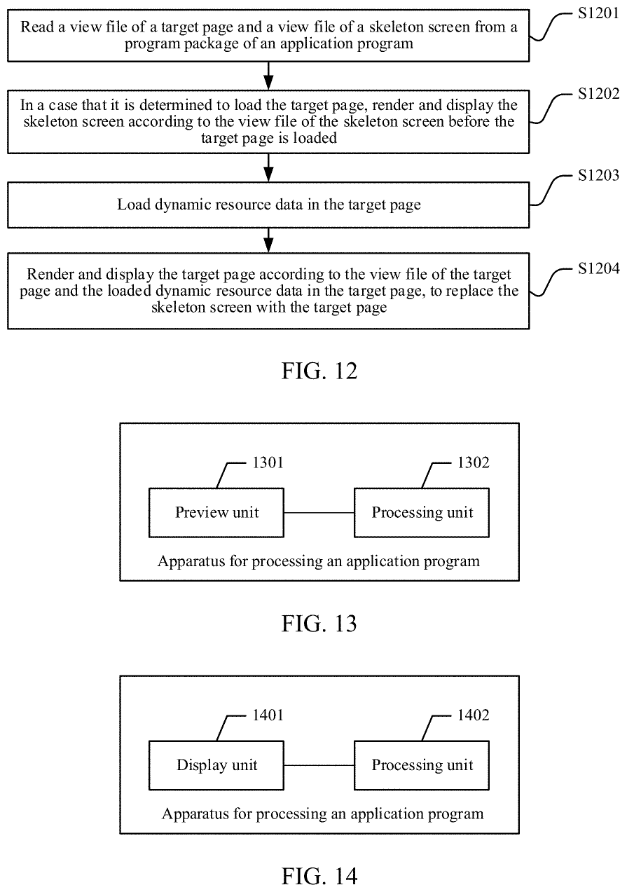

FIG. 12 is a flowchart of another page processing method according to an exemplary embodiment of this application. The page processing method may be performed by the terminal 402 shown in FIG. 4. The method includes but is not limited to steps S1201 to S1204.

S1201. Read a view file of a target page and a view file of a skeleton screen from a program package of an application program, the view file of the target page and the view file of the skeleton screen having a mapping relationship, and the view file of the skeleton screen being generated according to the method of the embodiment shown in FIG. 4 to FIG. 9f.

S1202. When it is determined to load the target page, render and display the skeleton screen according to the view file of the skeleton screen before the target page is loaded.

S1203. Load dynamic resource data in the target page.

S1204. Render and display the target page according to the view file of the target page and the loaded dynamic resource data in the target page, to replace the skeleton screen with the target page.

The program package of the application program includes a configuration file of the application program. The configuration file includes configuration information of the skeleton screen. The configuration information of the skeleton screen includes a display configuration field of a placeholder element in the skeleton screen, and the display configuration field of the placeholder element is used for indicating that the placeholder element is displayed or hidden in the skeleton screen. In addition, page elements include key elements. There is correspondence between the key elements and the placeholder elements in the skeleton screen. The so-called correspondence means that each key element has a placeholder element corresponding to the each key element. When the key element is replaced, the key element is replaced with a placeholder element corresponding to the key element.

In one embodiment, a method for rendering and displaying the target page according to the view file of the target page and the loaded dynamic resource data in the target page, to replace the skeleton screen with the target page may include: sequentially rendering and displaying the key elements according to a chronological order of completion of loading of dynamic resource data of the key elements in the target page and according to the loaded dynamic resource data of the key elements and the view file of the target page, to sequentially replace the corresponding placeholder elements in the skeleton screen with the key elements in the target page. Specifically, the key elements in the target page may respectively transmit requests to a server to obtain the dynamic resource data corresponding to the key elements; according to different response times of responding to the requests, loading times of the dynamic resource data corresponding to the key elements have a chronological order; and the key elements in the target page are sequentially rendered and displayed according to the view file of the target page and the dynamic resource data corresponding to the key elements. In other words, the key elements in the target page are sequentially replaced with the placeholder elements in the skeleton screen according to the chronological order of loading the dynamic resource data, so as to realize a progressive loading effect of the key elements in the target page. It may be understood that the progressive loading effect may be controlled by setData in the configuration information of the skeleton screen, for example, a node corresponding to a placeholder element that declares a data-skeleton-show attribute is replaced with a hidden attribute by real data of a corresponding page element, so that the progressive loading effect can be achieved. Certainly, if the progressive loading effect is not configured, the target page may be used to replace the skeleton screen after the target page is fully loaded.

In this embodiment of this application, in a process of starting the application program, when the target page in the application program is loaded, the skeleton screen of the target page can be first rendered and displayed based on a file of the skeleton screen that has a mapping relationship with the target page in the program package of the application program, and after content of the target page is loaded, the target page is then used to replace the skeleton screen. In this process, the anxiety of the user while waiting can be effectively reduced, and the competitiveness of the application program and the user experience can be improved.

FIG. 13 is a schematic structural diagram of a page processing apparatus according to an exemplary embodiment of this application. The page processing apparatus may be a computer program (including program code) for running on the terminal 401, for example, the page processing apparatus may be a developer tool running on the terminal 401. The page processing apparatus may be configured to perform some or all of the steps in the method embodiments shown FIG. 5 and FIG. 10. Referring to FIG. 13, the page processing apparatus includes the following units:

a preview unit 1301, configured to preview a target page in an application program; and

a processing unit 1302, configured to obtain a page structure of the previewed target page, the page structure of the target page being used for identifying a layout of page elements of the target page in the target page; obtain a page structure of a skeleton screen corresponding to the target page based on the page structure of the target page, the page structure of the skeleton screen being used for identifying a layout of placeholder elements of the skeleton screen in the skeleton screen, the placeholder elements being obtained by processing the page elements; and generate a view file of the skeleton screen according to the page structure of the skeleton screen, the skeleton screen being used for being displayed before the target page is loaded.

In one embodiment, the application program is an instant app program, and the application program is any application program running on a client; when the application program runs on the client, the client and the application program have a parent-child relationship, the client is a parent program of the application program, and the application program is a child program of the client;

the application program includes a logic layer and a view layer, a task of the logic layer is executed in a logic thread, and a task of the view layer is executed in a rendering thread; and

the target page is any page in the application program.

In one embodiment, the page elements include key elements and non-key elements; and the processing unit 1302 is further configured to:

delete the non-key elements in the page elements; and

replace the key elements with the placeholder elements to obtain the page structure of the skeleton screen,

types of the key elements including any one or a combination of the following: a text element, an image element, a button element, a form element, a pseudo-class element, or a native component; and the placeholder elements being capable of gray blocks.

In one embodiment, the target page includes a logic file and configuration information, and the page structure of the target page is determined by the logic file and the configuration information of the target page.

The configuration information of the target page includes display configuration fields of the page elements, and the display configuration fields of the page elements are used for indicating that the page elements are displayed or hidden in the target page.

The key elements include the page elements that are in the target page and in which the display configuration fields are used for indicating that the target page is displayed; and the non-key elements include other page elements other than the key elements in the target page.

In one embodiment, the processing unit 1302 is further configured to:

parse the logic file of the target page, to convert the logic file of the target page into a document object model tree, the document object model tree including a plurality of nodes, and each node being corresponding to one page element in the target page; and

crop the document object model tree according to the configuration information of the target page, to remove the nodes in the document object model tree corresponding to the non-key elements in the target page.

In one embodiment, the processing unit 1302 is further configured to:

obtain position attributes and style attributes of the nodes from the cropped document object model tree;

perform attribute processing on the nodes in the cropped document object model tree, the attribute processing including determining the position attributes of the nodes as position attributes of the placeholder elements, and replacing the style attributes of the nodes with style attributes of the placeholder elements;

convert the document object model tree obtained after the attribute processing into a logic file of the skeleton screen;

set configuration information for the skeleton screen, the configuration information of the skeleton screen being used for controlling a display effect of the skeleton screen; and

determine the page structure of the skeleton screen according to the logic file of the skeleton screen and the configuration information of the skeleton screen.

In one embodiment, the view file includes a view code file and a view style file. The view code file of the skeleton screen is used for describing a layout position of the placeholder element of the skeleton screen in the skeleton screen, and the view style file of the skeleton screen is used for describing a style of the placeholder element of the skeleton screen. According to an embodiment of this application, the units of the page processing apparatus shown in FIG. 13 may be separately or wholly combined into one or several other units, or one (or more) of the units herein may further be divided into a plurality of units of smaller functions. Accordingly, same operations may be implemented, and the implementation of the technical effects of the embodiments of this application is not affected. The foregoing units are divided based on logical functions. In an actual application, a function of one unit may also be implemented by a plurality of units, or functions of a plurality of units are implemented by one unit. In other embodiments of this application, the page processing apparatus may also include other units. In an actual application, the functions may also be cooperatively implemented by other units and may be cooperatively implemented by a plurality of units. According to another embodiment of this application, a computer program (including program code) that can perform the steps in the corresponding methods shown in FIG. 5 and FIG. 10 may be run on a general computing device, such as a computer, which include processing elements and storage elements such as a central processing unit (CPU), a random access memory (RAM), and a read-only memory (ROM), to construct the page processing apparatus shown in FIG. 13, and implement the page processing method in the embodiments of this application. The computer program may be recorded on, for example, a computer-readable recording medium, and may be loaded into the foregoing computing device by using the computer-readable recording medium and run on the computing device.

In the embodiments of this application, in a process of previewing the target page of the application program, the page structure of the previewed target page is obtained, the page elements are directly processed based on the page structure of the target page, to obtain the page structure of the skeleton screen corresponding to the target page, and the view file of the skeleton screen is generated according to the page structure of the skeleton screen. In this process, the view file of the corresponding skeleton screen is automatically generated by directly obtaining the page structure of the target page. There is no need to separately write code for the skeleton screen, avoiding code invasion, and regardless of how the target page changes, the view file of the corresponding skeleton screen can be quickly generated by previewing, so that the implementation process of the skeleton screen is not only efficient but also flexible.

FIG. 14 is a schematic structural diagram of another page processing apparatus according to an exemplary embodiment of this application. The page processing apparatus may be a computer program (including program code) for running on the terminal 401, for example, the page processing apparatus may be a developer tool running on the terminal 401. The page processing apparatus may be configured to perform some or all of the steps in the method embodiments shown FIG. 5 and FIG. 10. Referring to FIG. 14, the page processing apparatus includes the following units:

a display unit 1401, configured to display a preview interface, the preview interface including a target page previewed in an application program, and the preview interface further including a trigger control; and

a processing unit 1402, configured to generate a view file of a skeleton screen corresponding to the target page according to the page processing method when the trigger control is selected; obtain a view file of the target page, and establish a mapping relationship between the view file of the target page and the view file of the skeleton screen; and package the view file of the target page and the view file of the skeleton screen that have the mapping relationship into a program package of the application program.

In one embodiment, the view file includes a view code file and a view style file; and the processing unit 1402 is further configured to:

store the view file of the target page and the view file of the skeleton screen in the same level path directory; and

introduce a view code file of the skeleton screen into the view code file of the target page, and introduce a view style file of the skeleton screen into the view style file of the target page,

the target page including page elements, the page elements including static resource data and dynamic resource data, and the view file of the target page being generated according to the static resource data of the page elements in the target page; and

the program package of the application program further including a configuration file of the application program, the configuration file including configuration information of the target page and configuration information of the skeleton screen, and the configuration information of the skeleton screen being used for controlling a display effect of the skeleton screen.

According to an embodiment of this application, the units of the page processing apparatus shown in FIG. 14 may be separately or wholly combined into one or several other units, or one (or more) of the units herein may further be divided into a plurality of units of smaller functions. Accordingly, same operations may be implemented, and the implementation of the technical effects of the embodiments of this application is not affected. The foregoing units are divided based on logical functions. In an actual application, a function of one unit may also be implemented by a plurality of units, or functions of a plurality of units are implemented by one unit. In other embodiments of this application, the page processing apparatus may also include other units. In an actual application, the functions may also be cooperatively implemented by other units and may be cooperatively implemented by a plurality of units. According to another embodiment of this application, a computer program (including program code) that can perform the steps in the corresponding methods shown in FIG. 5 and FIG. 10 may be run on a general computing device, such as a computer, which include processing elements and storage elements such as a CPU, a RAM, and a ROM, to construct the page processing apparatus shown in FIG. 14, and implement the page processing method in the embodiments of this application. The computer program may be recorded on, for example, a computer-readable recording medium, and may be loaded into the foregoing computing device by using the computer-readable recording medium and run on the computing device.

In this embodiment of this application, by using the trigger control in the preview interface, the view file of the skeleton screen corresponding to the previewed target page may be triggered and generated, and the mapping relationship between the view file of the target page and the view file of the skeleton screen may be established; and the view file of the target page and the view file of the skeleton screen that have the mapping relationship are packaged into the program package of the application program. Accordingly, the program package of the application program including the view file of the target page and the view file of the skeleton screen is generated. After a developer releases the program package of the application program, a skeleton screen implementation solution is introduced into a starting process of the application program, which optimizes the starting process of the application program and a loading process of the target page, thereby helping improve user experience in using the application program.

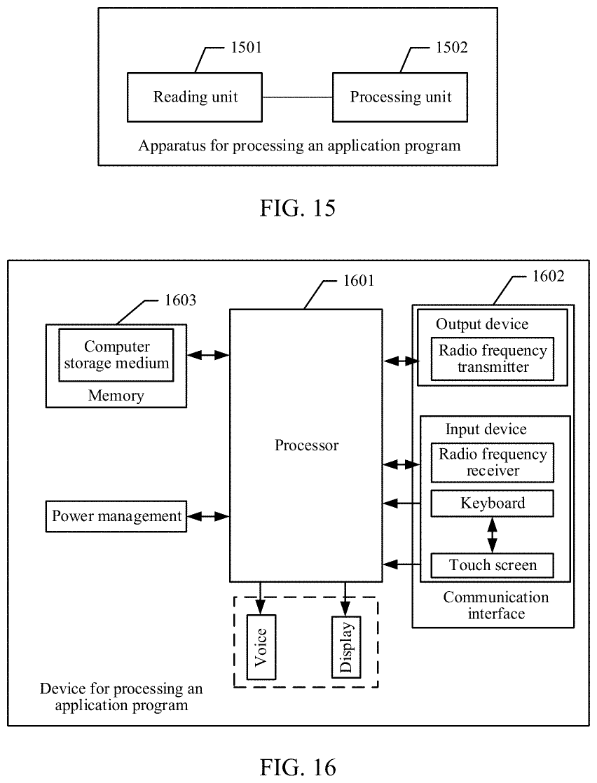

FIG. 15 is a schematic structural diagram of still another page processing apparatus according to an exemplary embodiment of this application. The page processing apparatus may be a computer program (including program code) for running on the terminal 402. For example, the page processing apparatus may be a client (such as a WeChat client) in the terminal 402, and an application program is an application program running on the client. The client and the application program have a parent-child relationship, the client is a parent program of the application program, and the application program is a child program of the client. The page processing apparatus may be configured to perform some or all of the steps in the method embodiments shown FIG. 12. Referring to FIG. 15, the page processing apparatus includes the following units:

a reading unit 1501, configured to read a view file of a target page and a view file of a skeleton screen from a program package of an application program, the view file of the target page and the view file of the skeleton screen having a mapping relationship, and the view file of the skeleton screen being generated according to the page processing method; and

a processing unit 1502, configured to render and display, when it is determined to load the target page, the skeleton screen according to the view file of the skeleton screen before the target page is loaded; load dynamic resource data in the target page; and render and display the target page according to the view file of the target page and the loaded dynamic resource data in the target page, to replace the skeleton screen with the target page.

In one embodiment, the target page includes page elements, the page elements include static resource data and dynamic resource data, and the view file of the target page is generated according to the static resource data of the page elements in the target page; and the dynamic resource data in the target page is the dynamic resource data of the page elements in the target page.

The program package of the application program further includes a configuration file of the application program, and the configuration file includes configuration information of the skeleton screen. The configuration information of the skeleton screen includes display configuration fields of placeholder elements in the skeleton screen, and the display configuration fields of the placeholder elements are used for indicating that the placeholder elements are displayed or hidden in the skeleton screen, and the target page includes key elements, and the key elements and the placeholder elements in the skeleton screen have a correspondence. The processing unit 1502 is further configured to:

sequentially render and display the key elements according to a chronological order of completion of loading of dynamic resource data of the key elements in the target page and according to the loaded dynamic resource data of the key elements and the view file of the target page, to sequentially replace the corresponding placeholder elements in the skeleton screen with the key elements in the target page.

In this technical solution, the key elements are sequentially rendered and displayed according to the chronological order of completion of loading of the dynamic resource data of the key elements, to sequentially replace the corresponding placeholder elements in the skeleton screen by using the key elements in the target page. Accordingly, a progressive loading effect of the page elements in the target page may be achieved.

According to an embodiment of this application, the units of the page processing apparatus shown in FIG. 15 may be separately or wholly combined into one or several other units, or one (or more) of the units herein may further be divided into a plurality of units of smaller functions. Accordingly, same operations may be implemented, and the implementation of the technical effects of the embodiments of this application is not affected. The foregoing units are divided based on logical functions. In an actual application, a function of one unit may also be implemented by a plurality of units, or functions of a plurality of units are implemented by one unit. In other embodiments of this application, the page processing apparatus may also include other units. In an actual application, the functions may also be cooperatively implemented by other units and may be cooperatively implemented by a plurality of units. According to another embodiment of this application, a computer program (including program code) that can perform the steps in the corresponding methods shown in FIG. 12 may be run on a general computing device, such as a computer, which include processing elements and storage elements such as a CPU, a RAM, and a ROM, to construct the page processing apparatus shown in FIG. 15, and implement the page processing method in the embodiments of this application. The computer program may be recorded on, for example, a computer-readable recording medium, and may be loaded into the foregoing computing device by using the computer-readable recording medium and run on the computing device.

In this embodiment of this application, in a process of starting the application program, when the target page in the application program is loaded, the skeleton screen of the target page can be first rendered and displayed based on a file of the skeleton screen that has a mapping relationship with the target page in the program package of the application program, and after content of the target page is loaded, the target page is then used to replace the skeleton screen. In this process, the anxiety of the user while waiting can be effectively reduced, and the competitiveness of the application program and the user experience can be improved.

FIG. 16 is a schematic structural diagram of a page processing device according to an exemplary embodiment of this application. Referring to FIG. 16, the page processing device includes a processor 1601, a communication interface 1602, and a computer-readable storage medium 1603. The processor 1601, the communication interface 1602, and the computer-readable storage medium 1603 may be connected by using a bus or in another method. The communication interface 1602 is configured to receive and transmit data. The computer-readable storage medium 1603 may be stored in a memory of the page processing device. The computer-readable storage medium 1603 is configured to store a computer program. The computer program includes program instructions. The processor 1601 is configured to execute the program instructions stored in the computer-readable storage medium 1603. The processor 1601 (or referred to as a CPU) is a computing core and a control core of the page processing device, is suitable for implementing one or more instructions, and is specifically suitable for loading and executing one or more instructions to implement a corresponding method procedure or a corresponding function.

The embodiments of this application further provide a computer-readable storage medium, and the computer-readable storage medium is a memory device in a page processing device and is configured to store programs and data. It may be understood that the computer-readable storage medium herein may include an internal storage medium of the page processing device and certainly may also include an extended storage medium supported by the page processing device. The computer-readable storage medium provides storage space, and the storage space stores a processing system of the page processing device. In addition, the storage space further stores one or more instructions suitable for being loaded and executed by the processor 1601. The instructions may be one or more computer programs (including program code). The computer-readable storage medium herein may be a high-speed RAM memory, or may be a non-volatile memory, such as at least one magnetic disk storage. In some embodiments, the computer-readable storage medium may be at least one computer storage medium far away from the foregoing processor.

In an embodiment, the page processing device may be the terminal 401 shown in FIG. 4. The computer-readable storage medium may store one or more first instructions; and the one or more first instructions in the computer-readable storage medium may be loaded and executed by the processor 1601 to implement corresponding steps in the page processing method embodiments. During specific implementation, the one or more first instructions in the computer-readable storage medium are loaded by the processor 1601 to perform the following steps:

previewing a target page in an application program;

obtaining a page structure of the previewed target page, the page structure of the target page being used for identifying a layout of page elements of the target page in the target page;

obtaining a page structure of a skeleton screen corresponding to the target page based on the page structure of the target page, the page structure of the skeleton screen being used for identifying a layout of placeholder elements of the skeleton screen in the skeleton screen, the placeholder elements being obtained by processing the page elements; and

generating a view file of the skeleton screen according to the page structure of the skeleton screen, the skeleton screen being used for being displayed before the target page is loaded.

In one embodiment, the application program is an instant app program, and the application program is any application program running on a client; when the application program runs on the client, the client and the application program have a parent-child relationship, the client is a parent program of the application program, and the application program is a child program of the client;

the application program includes a logic layer and a view layer, a task of the logic layer is executed in a logic thread, and a task of the view layer is executed in a rendering thread; and

the target page is any page in the application program.

In one embodiment, the page elements include key elements and non-key elements; and when the one or more first instructions in the computer-readable storage medium are loaded by the processor 1601 to perform a step of obtaining, based on the page structure of the target page, a page structure of a skeleton screen corresponding to the target page by processing the page elements, the following steps are further performed:

deleting the non-key elements in the page elements; and

replacing the key elements with the placeholder elements to obtain the page structure of the skeleton screen,

types of the key elements including any one or a combination of the following: a text element, an image element, a button element, a form element, a pseudo-class element, or a native component.

In one embodiment, the target page includes a logic file and configuration information, and the page structure of the target page is determined by the logic file and the configuration information of the target page.

The configuration information of the target page includes display configuration fields of the page elements, and the display configuration fields of the page elements are used for indicating that the page elements are displayed or hidden in the target page.

The key elements include the page elements that are in the target page and in which the display configuration fields are used for indicating that the target page is displayed; and the non-key elements include other page elements other than the key elements in the target page.

In one embodiment, when the one or more first instructions in the computer-readable storage medium are loaded by the processor 1601 to perform the step of deleting the non-key elements in the target pages, the following steps are further performed:

parse the logic file of the target page, to convert the logic file of the target page into a document object model tree, the document object model tree including a plurality of nodes, and each node being corresponding to one page element in the target page; and

crop the document object model tree according to the configuration information of the target page, to remove the nodes in the document object model tree corresponding to the non-key elements in the target page.

In one embodiment, the cropped document object model tree may only include nodes corresponding to the key elements in the target page.

When the one or more first instructions in the computer-readable storage medium are loaded by the processor 1601 to perform the step of replacing the key elements in the target page with the placeholder elements to obtain the page structure of the skeleton screen, the following steps are further performed:

obtaining position attributes and style attributes of the nodes from the cropped document object model tree;

performing attribute processing on the nodes in the cropped document object model tree, the attribute processing including determining the position attributes of the nodes as position attributes of the placeholder elements, and replacing the style attributes of the nodes with style attributes of the placeholder elements;

converting the document object model tree obtained after the attribute processing into a logic file of the skeleton screen;

setting configuration information for the skeleton screen, the configuration information of the skeleton screen being used for controlling a display effect of the skeleton screen; and

jointly determining the page structure of the skeleton screen according to the logic file of the skeleton screen and the configuration information of the skeleton screen.

In one embodiment, the view file includes a view code file and a view style file, the view code file of the skeleton screen is used for describing a layout position of the placeholder element of the skeleton screen in the skeleton screen, and the view style file of the skeleton screen is used for describing a style of the placeholder element of the skeleton screen.

In the embodiments of this application, in a process of previewing the target page of the application program, the page structure of the previewed target page is obtained, the page elements are directly processed based on the page structure of the target page, to obtain the page structure of the skeleton screen corresponding to the target page, and the view file of the skeleton screen is generated according to the page structure of the skeleton screen. In this process, the view file of the corresponding skeleton screen is automatically generated by directly obtaining the page structure of the target page. There is no need to separately write code for the skeleton screen, avoiding code invasion, and regardless of how the target page changes, the view file of the corresponding skeleton screen can be quickly generated by previewing, so that the implementation process of the skeleton screen is not only efficient but also flexible.

In another embodiment, the page processing device may be the terminal 401 shown in FIG. 4. The computer-readable storage medium may store one or more second instructions; and the one or more second instructions in the computer-readable storage medium may be loaded and executed by the processor 1601 to implement corresponding steps in the page processing method embodiments. During specific implementation, the one or more second instructions in the computer-readable storage medium are loaded by the processor 1601 to perform the following steps:

displaying a preview interface, the preview interface including a target page previewed in an application program, and the preview interface further including a trigger control; and

when the trigger control is selected, generating a view file of a skeleton screen corresponding to the target page according to the page processing method;

obtaining a view file of the target page, and establishing a mapping relationship between the view file of the target page and the view file of the skeleton screen; and

packaging the view file of the target page and the view file of the skeleton screen that have the mapping relationship into a program package of the application program.

In one embodiment, the view file includes a view code file and a view style file; and

when the one or more second instructions in the computer-readable storage medium are loaded by the processor 1601 to perform the step of establishing a mapping relationship between the view file of the target page and the view file of the skeleton screen, the following steps are further performed:

storing the view file of the target page and the view file of the skeleton screen in the same level path directory; and

introducing a view code file of the skeleton screen into the view code file of the target page, and introducing a view style file of the skeleton screen into the view style file of the target page,

the target page including page elements, the page elements including static resource data and dynamic resource data, and the view file of the target page being generated according to the static resource data of the page elements in the target page; and

the program package of the application program further including a configuration file of the application program, the configuration file including configuration information of the target page and configuration information of the skeleton screen, the configuration information of the skeleton screen being used for controlling a display effect of the skeleton screen.

In this embodiment of this application, by using the trigger control in the preview interface, the view file of the skeleton screen corresponding to the previewed target page may be triggered and generated, and the mapping relationship between the view file of the target page and the view file of the skeleton screen may be established; and the view file of the target page and the view file of the skeleton screen that have the mapping relationship are packaged into the program package of the application program. Accordingly, the program package of the application program including the view file of the target page and the view file of the skeleton screen is generated. After a developer releases the program package of the application program, a skeleton screen implementation solution is introduced into a starting process of the application program, which optimizes the starting process of the application program and a loading process of the target page, thereby helping improve user experience in using the application program.

In still another embodiment, the page processing device may be the terminal 402 shown in FIG. 4. The computer-readable storage medium may store one or more third instructions; and the one or more third instructions in the computer-readable storage medium may be loaded and executed by the processor 1601 to implement corresponding steps in the page processing method embodiments. During specific implementation, the one or more third instructions in the computer-readable storage medium are loaded by the processor 1601 to perform the following steps:

reading a view file of a target page and a view file of a skeleton screen from a program package of an application program, the view file of the target page and the view file of the skeleton screen having a mapping relationship, and the view file of the skeleton screen being generated according to the page processing method; and

when it is determined to load the target page, rendering and displaying the skeleton screen according to the view file of the skeleton screen before the target page is loaded;

loading dynamic resource data in the target page; and

rendering and displaying the target page according to the view file of the target page and the loaded dynamic resource data in the target page, to replace the skeleton screen with the target page.

In one embodiment, the target page includes page elements, the page elements include static resource data and dynamic resource data, and the view file of the target page is generated according to the static resource data of the page elements in the target page; and the dynamic resource data in the target page is the dynamic resource data of the page elements in the target page.

The program package of the application program further includes a configuration file of the application program, and the configuration file includes configuration information of the skeleton screen. The configuration information of the skeleton screen includes display configuration fields of placeholder elements in the skeleton screen, and the display configuration fields of the placeholder elements are used for indicating that the placeholder elements are displayed or hidden in the skeleton screen, and the target page includes key elements, and the key elements and the placeholder elements in the skeleton screen have a correspondence.

When the one or more third instructions in the computer-readable storage medium are loaded by the processor 1601 to perform the step of rendering and displaying the target page according to the view file of the target page and the loaded dynamic resource data in the target page, to replace the skeleton screen with the target page, the following steps are further performed:

An embodiment of this application further provides a computer program product including instructions, the computer program product, when run on a computer, causing the computer to perform the method according to the foregoing embodiments.

sequentially rendering and displaying the key elements according to a chronological order of completion of loading of dynamic resource data of the key elements in the target page and according to the loaded dynamic resource data of the key elements and the view file of the target page, to sequentially replace the corresponding placeholder elements in the skeleton screen with the key elements in the target page.

In this embodiment of this application, in a process of starting the application program, when the target page in the application program is loaded, the skeleton screen of the target page can be first rendered and displayed based on a file of the skeleton screen that has a mapping relationship with the target page in the program package of the application program, and after content of the target page is loaded, the target page is then used to replace the skeleton screen. In this process, the anxiety of the user while waiting can be effectively reduced, and the competitiveness of the application program and the user experience can be improved.

A person of ordinary skill in the art may notice that the exemplary units and algorithm steps described with reference to the embodiments disclosed in this application can be implemented in electronic hardware, or a combination of computer software and electronic hardware. Whether the functions are executed in a mode of hardware or software depends on particular applications and design constraint conditions of the technical solutions. A person skilled in the art may use different methods to implement the described functions for each particular application, but it is not to be considered that the implementation goes beyond the scope of this application.

All or some of the foregoing embodiments may be implemented by using software, hardware, firmware, or any combination thereof. When the software is used for implementation, all or some of the embodiments may be implemented in a form of a computer program product. The computer program product includes one or more computer instructions. When the computer program instructions are loaded and executed on a computer, the procedures or functions according to the embodiments of this application are all or partially generated. The computer may be a general-purpose computer, a special-purpose computer, a computer network, or another programmable device. The computer instructions may be stored in a computer-readable storage medium or transmitted through the computer-readable storage medium. The computer instructions may be transmitted from a website, a computer, a server, or a data center to another website, computer, server, or data center in a wired (for example, a coaxial cable, an optical fiber, or a digital subscriber line (DSL)) or wireless (for example, infrared, radio, or microwave) method. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid state disk (SSD)), or the like.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A page processing method, performed by a terminal, the method comprising:
previewing a target page in an application program;
obtaining a page structure of the previewed target page, the page structure of the target page identifying a layout of page elements of the target page in the target page;
obtaining a page structure of a skeleton screen corresponding to the target page based on the page structure of the target page, the page structure of the skeleton screen identifying a layout of placeholder elements of the skeleton screen on the skeleton screen, the placeholder elements being obtained by processing the page elements; and
generating a view file of the skeleton screen according to the page structure of the skeleton screen, the skeleton screen being displayed before the target page is loaded.

2. The method according to claim 1, wherein the application program is an instant app program, or the application program is any application program running on a client; when the application program runs on the client, the client and the application program have a parent-child relationship, the client is a parent program of the application program, and the application program is a child program of the client;
the application program comprises a logic layer and a view layer, a task of the logic layer is executed in a logic thread, and a task of the view layer is executed in a rendering thread; and
the target page is any page in the application program.

3. The method according to claim 1, wherein the page elements comprise key elements and non-key elements; and the obtaining a page structure of a skeleton screen corresponding to the target page based on the page structure of the target page comprises:
deleting the non-key elements in the page elements; and
replacing the key elements with the placeholder elements to obtain the page structure of the skeleton screen,
types of the key elements comprising any one or a combination of the following: a text element, an image element, a button element, a form element, a pseudo-class element, or a native component.

4. The method according to claim 3, wherein the target page comprises a logic file and configuration information, the page structure of the target page is determined by the logic file and the configuration information of the target page;
the configuration information of the target page comprises display configuration fields of the page elements, and the display configuration fields of the page elements indicating that the page elements are displayed or hidden in the target page; and
the key elements comprise the page elements that are in the target page and in which the display configuration fields indicating that the target page is displayed; and the non-key elements comprise other page elements other than the key elements in the target page.

5. The method according to claim 4, wherein the deleting the non-key elements in the page elements comprises:
parsing the logic file of the target page, to convert the logic file of the target page into a document object model tree, the document object model tree comprising a plurality of nodes, and one node being corresponding to one page element in the target page; and
cropping the document object model tree according to the configuration information of the target page, to remove the nodes in the document object model tree corresponding to the non-key elements.

6. The method according to claim 5, wherein the replacing the key elements with the placeholder elements to obtain the page structure of the skeleton screen comprises:
obtaining position attributes and style attributes of the nodes from the cropped document object model tree;
performing attribute processing on the nodes in the cropped document object model tree, the attribute processing comprising determining the position attributes of the nodes as position attributes of the placeholder elements, and replacing the style attributes of the nodes with style attributes of the placeholder elements;
converting the document object model tree obtained after the attribute processing into a logic file of the skeleton screen;
setting configuration information for the skeleton screen, the configuration information of the skeleton screen being used for controlling a display effect of the skeleton screen; and
determining the page structure of the skeleton screen according to the logic file of the skeleton screen and the configuration information of the skeleton screen.

7. The method according to claim 1, wherein the view file comprises a view code file and a view style file, the view code file of the skeleton screen describing a layout position of the placeholder element of the skeleton screen in the skeleton screen, and the view style file of the skeleton screen describing a style of the placeholder element of the skeleton screen.

8. The method according to claim 1, further comprising:
displaying a preview interface, the preview interface comprising the target page previewed in the application program, and the preview interface further comprising a trigger control;
when the trigger control is selected, generating the view file of the skeleton screen corresponding to the target page;
obtaining a view file of the target page, and establishing a mapping relationship between the view file of the target page and the view file of the skeleton screen; and
packaging the view file of the target page and the view file of the skeleton screen that have the mapping relationship into a program package of the application program.

9. The method according to claim 8, wherein the view file comprises a view code file and a view style file; and the establishing a mapping relationship between the view file of the target page and the view file of the skeleton screen comprises:
storing the view file of the target page and the view file of the skeleton screen in a same level path directory; and
introducing the view code file of the skeleton screen into the view code file of the target page, and introducing the view style file of the skeleton screen into the view style file of the target page,
the target page comprising page elements, the page elements comprising static resource data and dynamic resource data, and the view file of the target page being generated according to the static resource data of the page elements in the target page; and
the program package of the application program further comprising a configuration file of the application program, the configuration file comprising configuration information of the target page and configuration information of the skeleton screen, the configuration information of the skeleton screen being used for controlling a display effect of the skeleton screen.

10. The method according to claim 1, further comprising:
reading a view file of a target page and the view file of the skeleton screen from a program package of the application program, the view file of the target page and the view file of the skeleton screen having a mapping relationship;
when it is determined to load the target page, rendering and displaying the skeleton screen according to the view file of the skeleton screen before the target page is loaded;
loading dynamic resource data in the target page; and
rendering and displaying the target page according to the view file of the target page and the loaded dynamic resource data in the target page, to replace the skeleton screen with the target page.

11. The method according to claim 10, wherein the target page comprises page elements, the page elements comprise static resource data and dynamic resource data, and the view file of the target page is generated according to the static resource data of the page elements in the target page; and the dynamic resource data in the target page is the dynamic resource data of the page elements in the target page;
the program package of the application program further comprises a configuration file of the application program, the configuration file comprises configuration information of the skeleton screen; the configuration information of the skeleton screen comprises display configuration fields of placeholder elements in the skeleton screen, and the display configuration fields of the placeholder elements are used for indicating that the placeholder elements are displayed or hidden in the skeleton screen; and the target page comprises key elements, and the key elements and the placeholder elements in the skeleton screen have a correspondence; and
the rendering and displaying the target page according to the view file of the target page and the loaded dynamic resource data in the target page, to replace the skeleton screen with the target page comprises:
sequentially rendering and displaying the key elements according to a chronological order of completion of loading of dynamic resource data of the key elements in the target page and according to the loaded dynamic resource data of the key elements and the view file of the target page, to sequentially replace the corresponding placeholder elements in the skeleton screen with the key elements in the target page.

12. A non-transitory computer storage medium, the storage medium being configured to store a computer program, the computer program, when being executed by a processor, cause the processor perform comprising:
previewing a target page in an application program;
obtaining a page structure of the previewed target page, the page structure of the target page identifying a layout of page elements of the target page in the target page;
obtaining a page structure of a skeleton screen corresponding to the target page based on the page structure of the target page, the page structure of the skeleton screen identifying a layout of placeholder elements of the skeleton screen on the skeleton screen, the placeholder elements being obtained by processing the page elements; and
generating a view file of the skeleton screen according to the page structure of the skeleton screen, the skeleton screen being displayed before the target page is loaded.

13. The computer storage medium according to claim 12, wherein the application program is an instant app program, or the application program is any application program running on a client; when the application program runs on the client, the client and the application program have a parent-child relationship, the client is a parent program of the application program, and the application program is a child program of the client;
the application program comprises a logic layer and a view layer, a task of the logic layer is executed in a logic thread, and a task of the view layer is executed in a rendering thread; and
the target page is any page in the application program.

14. The computer storage medium according to claim 12, wherein the page elements comprise key elements and non-key elements; and the obtaining a page structure of a skeleton screen corresponding to the target page based on the page structure of the target page comprises:
deleting the non-key elements in the page elements; and
replacing the key elements with the placeholder elements to obtain the page structure of the skeleton screen,
types of the key elements comprising any one or a combination of the following: a text element, an image element, a button element, a form element, a pseudo-class element, or a native component.

15. The computer storage medium according to claim 14, wherein the target page comprises a logic file and configuration information, the page structure of the target page is determined by the logic file and the configuration information of the target page;
the configuration information of the target page comprises display configuration fields of the page elements, and the display configuration fields of the page elements indicating that the page elements are displayed or hidden in the target page; and
the key elements comprise the page elements that are in the target page and in which the display configuration fields indicating that the target page is displayed; and the non-key elements comprise other page elements other than the key elements in the target page.

16. The computer storage medium according to claim 15, wherein the deleting the non-key elements in the page elements comprises:
parsing the logic file of the target page, to convert the logic file of the target page into a document object model tree, the document object model tree comprising a plurality of nodes, and one node being corresponding to one page element in the target page; and
cropping the document object model tree according to the configuration information of the target page, to remove the nodes in the document object model tree corresponding to the non-key elements.

17. The computer storage medium according to claim 16, wherein the replacing the key elements with the placeholder elements to obtain the page structure of the skeleton screen comprises:
obtaining position attributes and style attributes of the nodes from the cropped document object model tree;
performing attribute processing on the nodes in the cropped document object model tree, the attribute processing comprising determining the position attributes of the nodes as position attributes of the placeholder elements, and replacing the style attributes of the nodes with style attributes of the placeholder elements;
converting the document object model tree obtained after the attribute processing into a logic file of the skeleton screen;
setting configuration information for the skeleton screen, the configuration information of the skeleton screen being used for controlling a display effect of the skeleton screen; and
determining the page structure of the skeleton screen according to the logic file of the skeleton screen and the configuration information of the skeleton screen.

18. The computer storage medium according to claim 12, wherein the view file comprises a view code file and a view style file, the view code file of the skeleton screen describing a layout position of the placeholder element of the skeleton screen in the skeleton screen, and the view style file of the skeleton screen describing a style of the placeholder element of the skeleton screen.

19. The computer storage medium according to claim 12, wherein the computer program further cause the processor to perform:
displaying a preview interface, the preview interface comprising the target page previewed in the application program, and the preview interface further comprising a trigger control;
when the trigger control is selected, generating the view file of the skeleton screen corresponding to the target page;
obtaining a view file of the target page, and establishing a mapping relationship between the view file of the target page and the view file of the skeleton screen; and
packaging the view file of the target page and the view file of the skeleton screen that have the mapping relationship into a program package of the application program.

20. A page processing device, comprising a memory and a processor coupled to the memory, the processor being configured to perform:
previewing a target page in an application program;
obtaining a page structure of the previewed target page, the page structure of the target page identifying a layout of page elements of the target page in the target page;
obtaining a page structure of a skeleton screen corresponding to the target page based on the page structure of the target page, the page structure of the skeleton screen identifying a layout of placeholder elements of the skeleton screen on the skeleton screen, the placeholder elements being obtained by processing the page elements; and
generating a view file of the skeleton screen according to the page structure of the skeleton screen, the skeleton screen being displayed before the target page is loaded.
